(19) United States
(12) Patent Application Publication
(10) Pub. No.: US 2006/0050618 A1
(43) Pub. Date: Mar. 9, 2006

(54) Electronic timepiece with solar cell

(76) Inventors: Takashi Osa, Tokyo (JP); Tomomi Murakami, Tokyo (JP)

Correspondence Address: KANESAKA BERNER AND PARTNERS LLP, SUITE 300, 1700 DIAGONAL RD, ALEXANDRIA, VA, 22314-2848, US

(21) Appl. No.: 10/534,234

(22) PCT Filed: Dec. 16, 2003
(86) PCT No.: PCT/JP03/16077

§ 371 Date: May 6, 2005

(30) Foreign Application Priority Data
Dec. 16, 2002 (JP) 2002-363706

(51) Int. Cl. G04B 1/00

(52) U.S. Cl. 368/205

(57) ABSTRACT

In the present invention, a light permeable dial trim ring is arranged on the inner side of a solar cell, and a part of a solar cell photovoltaic area and a part of the dial trim ring which covers the solar cell photovoltaic area are arranged to be lower than a dial upper surface height. Further, a dial thickness of the dial inner side is set larger than a thickness of a dial peripheral edge on which the light permeable dial trim ring is mounted while assuring a light leading portion for a light which enters the dial trim ring. Alternatively, a flange portion which fixes a glass to a watch case is arranged outside the light permeable dial trim ring and the solar cell, the dial trim ring is arranged directly below the glass, and a blind portion is provided above the dial trim ring or the solar cell. As a result, a gap between the glass lower surface and the dial upper surface can be reduced, thereby eliminating a “hollow-eyed” design.

### TECHNICAL FIELD

The present invention relates to an electronic watch with a solar cell which is arranged in a dial trim portion in a watch having a solar power generation system which generates a power by utilizing a light and a charging system which charges a power generated by this solar power generation system.

### BACKGROUND ART

Many electronic watches each of which has a solar cell and utilizes a light such as a sunlight as a power generation source have been conventionally commercialized. In these electronic watches, a dial is restricted in design when a solar cell is arranged under the light semi-permeable dial, and hence commercial products having various designs cannot be proposed.

That is, since a surface of the solar cell has a dark brown color, the dial must be mounted on the solar cell in order to hide the color of this surface. On the other hand, in order to generate a power upon receiving a light by the solar cell, the dial must have properties which transmit a light therethrough to some extent, i.e., the light permeability. Therefore, even if an attempt to change a color of the dial to white is made, the dial has a grayish color tone like frosted glass, a beautiful white color cannot be provided, and hence there is a restriction in design.

Meanwhile, a reduction in power consumption of watches has advanced in recent years, and watches can be driven even if a superficial content of a solar cell is reduced to some extent. Thus, there has been proposed an electronic watch with a solar cell which is arranged on an outer periphery of a dial substantially vertically to the dial. As such a conventional example, there is a watch in which a solar cell formed on a flexible strip-like printed board is wound on a wall surface of a gap portion between a glass and a dial, which is disclosed in Japanese Utility Model Application Laid-open No. 42390-1987 (Patent Reference 1) or Japanese Patent Application Laid-open No. 2002-148366 (Patent Reference 2).

FIG. 10 is a cross-sectional view of a watch according to a first embodiment illustrated in FIG. 1 of Patent Reference 1. This watch has a solar cell block 23 in which a plurality of solar cells 20 are bonded to a printed board 21 and accommodated in a groove portion 22a of a support ring 22. This solar cell block 23 is arranged below a flange portion 26 which fixes a glass 24. A pent roof portion 22d which connects an inner peripheral ring 22b with an outer peripheral ring 22c is formed to the support ring 22. Further, the solar cells 20 have a configuration in which the solar cells 20 are arranged on a dial 25.

FIG. 11 is a cross-sectional view of a watch according to a second embodiment illustrated in FIG. 3 of Patent Reference 1. In this watch, a solar cell unit 36 is arranged in a gap portion between a glass 33 and a dial 34 in a state where the solar cell unit 36 is wound on an inner side of an inner wall surface of a dial trim portion 31 of a watch case 35. This solar cell unit 36 is formed by bonding a solar cell 30 made out of amorphous silicon is bonded to a stainless sheet 32.

Further, FIG. 12 is a cross-sectional view of a watch according to a first embodiment of Patent Reference 2. In this watch, a ring-shaped bank 45 is provided above a position at which a dial 43 of a watch movement 44 is arranged, and a solar cell 40 is arranged on an inner wall surface 46 of this bank 45. It is to be noted that reference numeral 41 denotes a glass and reference numeral 42 designate a flange portion on the side.

In the structure shown in FIG. 10, however, a gap dimension between the glass 24 and the dial 25 is a dimension obtained by adding up heights of the flange portion 26, the pent roof portion 22d and others as well as the solar cell 20. Therefore, the gap between the glass 24 and the dial 25 becomes large, resulting in a design problem that a position of the dial 25 is deeply set as seen from the glass 24, which is a so-called “hollow-eyed watch”. Furthermore, a hand position is deeply set or a hand gap is wide, and the design properties are deteriorated, thereby lowering a commercial value.

Moreover, in the structure shown in FIG. 11, the gap between the glass 33 an the dial 34 is narrowed since the flange portion is eliminated, but a width of the cell must be increased to some extent because of performances of the current solar cell, a height of the cell is large, and a gap of the cell is still wide. Additionally, since the solar cell 30 is exposed in the gap portion between the glass 33 and the dial 34, there occurs a design problem that the dark brown color inherent to the solar cell can be directly seen from the outside of the watch 35 and the solar cell 30 is distinctive as a black ring in case of a dial having a bright color in particular.

In the structure shown in FIG. 12, like the conventional example depicted in FIG. 10, the solar cell 40 is arranged below the flange portion 42 which fixes the glass 41. Therefore, the gap between the glass 41 and the dial 43 has a dimension obtained by adding up not only a height of the solar cell 40 but also a height of the flange portion, and hence the gap between the glass 41 and the dial 43 becomes wide. As a result, there occurs a design problem that a position of the dial 43 is deeply set as seen from the glass 41, thereby leading to a so called “hollow-eyed watch”.

As described above, in the prior art, the solar cell must have a fixed superficial content in order to obtain an energy which is sufficient to drive the watch and, even in case of a men's watch having a large dial trim diameter, i.e., a watch which can have an increased length of the solar cell, if the watch has a black dial, a necessary height of the solar cell becomes larger than a height of the gap between the glass and the dial in a watch which is not based on the solar power generation. As a result, there occurs a problem that the “hollow-eyed watch” is obtained.

Therefore, it is an object of the present invention to provide a watch which can assure a power generation quantity required to drive the watch, make a solar cell indistinctive but does not give a sense of the depth of a dial position in an electronic watch with a solar cell which is arranged substantially vertically with respect to a dial.

### DISCLOSURE OF THE INVENTION

The present invention has, in an electronic watch with a solar cell which is arranged substantially vertically with respect to a dial, a structure in which a light leading portion is provided at a peripheral edge of the dial, a light permeable dial trim ring is arranged at the peripheral edge of the dial and a part of the solar cell power generation area and a part of the dial trim ring which covers the power generation area of the solar cell are arranged to be lower than an upper surface height of the dial.

Although the light permeable dial trim ring and the dial are arranged in the solar cell, a light which is used to generate a power required for driving the watch can be taken in by providing the light leading portion which is an inlet for the light. Further, an incident light from the dial trim ring can be led to the solar cell arranged below the dial upper surface by arranging a part of the solar cell power generation area and a part of the dial trim ring which covers the solar cell power generation area to be lower than the upper surface height of the dial. As a result, it is not necessary to arrange the entire solar cell to be higher than the upper surface of the dial, a gap between a glass lower surface, and the dial upper surface can be reduced to be equivalent to the gap of a conventional electronic watch having a primary battery, thereby eliminating the problem of the “hollow-eyed watch”.

Furthermore, the present invention has a configuration in which a thickness of the inner side of the dial is larger than that of the peripheral edge.

By setting a thickness of the inner side of the dial where watch hands are arranged to be larger than a thickness of the peripheral edge of the dial where the dial trim ring is arranged, a gap from the glass lower surface to the dial upper surface can be narrowed while assuring a superficial content of a light incidence surface with respect to the dial trim ring required to generate a power which is necessary for driving the watch, thereby eliminating the “hollow eye” problem.

Moreover, the present invention has a structure in which the light leading portion has an inclined surface portion configured in such a manner that the thickness of the dial is reduced from the inner side toward the peripheral edge side.

Although a difference in thickness of the dial is produced by increasing the thickness of the inner side of the dial to be larger than the thickness of the peripheral edge, this difference can be made indistinctive by providing the inclined surface.

Additionally, in the present invention, the light leading portion is configured in such a manner that the thickness of the dial becomes small at the peripheral edge.

Although a step can be readily formed to the outer peripheral portion of the dial by press working, milling or the like, formation of the step can be likewise realized by attaching two circular plates having different outside diameters to each other, and there is a merit that the processing is easy as compared with a configuration in which an inclined surface is formed.

Further, the present invention has a structure in which an inclined surface portion is provided to the dial trim ring and an inclined surface or a step portion of the light leading portion of the dial is covered with the inclined surface portion.

By arranging the dial trim ring which covers the inclined surface or the step portion which is generated due to a difference in thickness between the inner side and the peripheral edge of the dial, the light leading portion which takes in a light with which a power generation quantity required to drive the watch can be assured is provided, and it is possible to realize an external appearance which has a flat dial as an external appearance of the watch and which is not different from a conventional electronic watch having a primary battery.

The present invention has a structure in which a flange portion which fixes a glass to a watch case is provided outside the dial trim ring, the solar cell and a watch movement or an annular convex portion of a casing frame which holds the solar cell, the dial trim ring is arranged directly below the glass, and a blind portion is provided above the dial trim ring of the glass and/or the solar cell in the watch case of the electronic watch with a solar cell.

Since the dial trim ring can be arranged directly below the glass, the gap between the glass and the upper surface of the dial can be reduced for an amount corresponding to the thickness of the flange portion, the gap equivalent to that of a conventional electronic watch having a primary battery can be obtained, and the solar cell can be hidden from a position directly above the glass.

As a result, the gap between the lower surface of the glass and the upper surface of the dial can be reduced by increasing the thickness of the inner side of the dial to be larger than the thickness of the peripheral edge of the dial while assuring the light leading portion for a light which enters the dial trim ring, thereby eliminating the “hollow-eyed” design.

### BRIEF DESCRIPTION OF THE DRAWINGS

FIG. 1 is a cross-sectional view of a primary part of an electronic watch with a solar cell, showing Embodiment 1 of a first embodiment according to the present invention;

FIG. 2 is a cross-sectional view of a primary part of an electronic watch with a solar cell, showing a second embodiment according to the present invention;

FIG. 3 is a plan view of a solar cell according to the present invention;

FIG. 4 is a perspective view showing a state of the solar cell assembled in the watch according to the present invention;

FIG. 5 is a plan view of a movement of the electronic watch with the solar cell according to the present invention;

FIG. 6 is a graph showing a light receiving efficiency with respect to a dial thickness based on Embodiment 1 of the first embodiment according to the present invention;

FIG. 7 is a cross-sectional view of a primary part of an electronic watch with a solar cell, showing a conformation with a different dial trim ring based on Embodiment 2 of the first embodiment according to the present invention;

FIG. 8 is a cross-sectional view of a primary part of an electronic watch with a solar cell, showing a conformation with a different dial shape based on Embodiment 3 of the first embodiment according to the present invention;

FIG. 9 is a cross-sectional view of a primary part of an electronic watch with a solar cell in which a solar cell is arranged in a casing frame, which is another conformation of Embodiment 1 of the first embodiment according to the present invention;

FIG. 10 is a cross-sectional view of a primary part of an electronic watch with a solar cell according to a prior art described in Patent Reference 1;

FIG. 11 is a cross-sectional view of a primary part of an electronic watch with a solar cell according to the prior art described in Patent Reference 1; and

FIG. 12 is a cross-sectional view of a primary part of an electronic watch with a solar cell according to a prior art described in Patent Reference 2.

### BEST MODE FOR CARRYING OUT THE INVENTION

Embodiments according to the present invention will now be described hereinafter with reference to the accompanying drawings.

It is to be noted that the present invention is not restricted the embodiments.

### First Embodiment

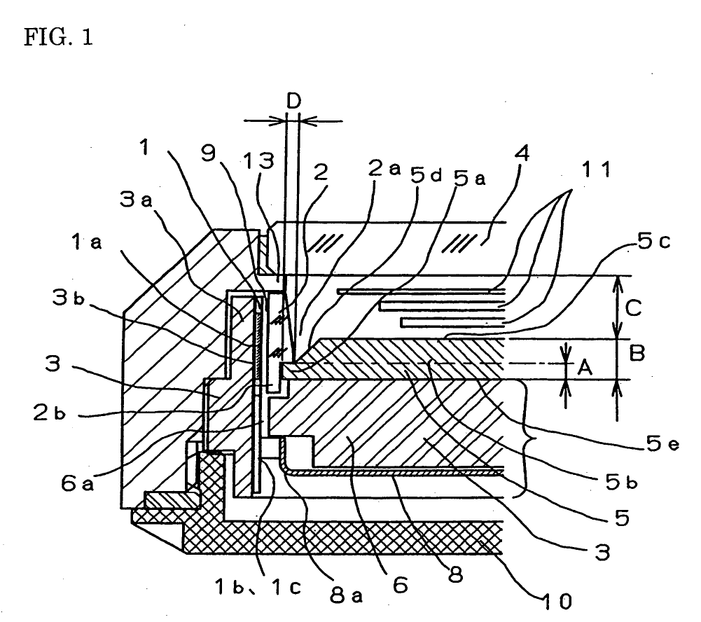

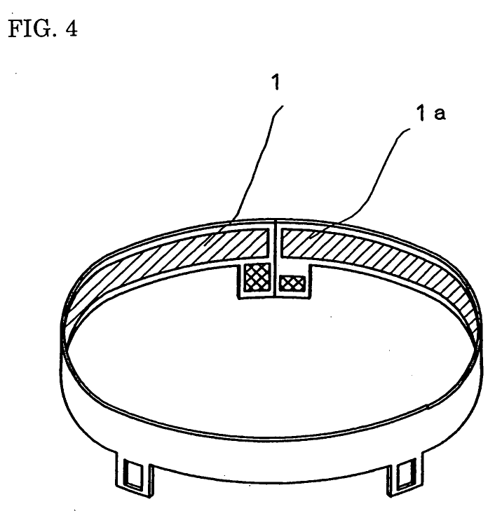

FIG. 1 is a cross-sectional view of a primary part of an electronic watch with a solar cell showing a first embodiment according to the present invention, FIG. 3 is a plan view of a solar cell of the embodiment according to the present invention, and FIG. 4 is a perspective view showing a state of the solar cell assembled in the watch of the embodiment according to the present invention.

First, a structure of the solar cell will be described with reference to FIG. 3. The solar cell 1 is obtained by forming an amorphous silicon layer or the like on a PET film of a base substrate, and it is a flexible solar cell having a thickness of approximately 150 μm and an elongated strip-like shape by which the solar cell can be bent and accommodated in a watch case as shown in FIG. 4.

The solar cell 1 according to this embodiment is an electric cell, and reference numeral 1a denotes a photovoltaic area; 1b and 1c, positive and negative electrodes which are used to take out a generated power; and 1d, a protrusion having a positioning hole which is used when assembling the solar cell in a watch movement. Further, an edge portion 1e having a width of approximately 400 μm where no power is generated even if a light is applied thereto is provided on the entire outer periphery of the photovoltaic area 1a, this is a cutting width which is used when cutting and separating each solar cell from a sheet obtained by forming many solar cells on a PET film. At the time of assembling, the solar cell is assembled into the watch in an annular form in such a manner that the photovoltaic area 1a faces the center of the watch as shown in FIG. 4.

In this embodiment, a circuit support 3 is extended in the vertical direction, and a part extended to the upper side is further extended to a glass 4 side, thereby forming an annular convex portion 3a. The solar cell 1 has the flexibility as described above, it is curled up and incorporated on an inner wall surface 3b of the annular concave portion 3a of the circuit support 3, and it is attached in such a shape as shown in FIG. 4 on the inner wall surface 3b of the convex portion 3a by the tensile force of the stretching solar cell itself.

A dial 5 is mounted oh the circuit support 3 provided on the watch center side apart from the solar cell 1 arranged in the annular form. A light permeable dial trim ring 2 is arranged on a peripheral edge 5a of this dial 5. That is, there is adopted a structure in which the dial trim ring 2 is arranged on the inner side of the solar cell 1. The dial 5 does not have an even thickness, and a thickness of the dial inner side 5b on which hour, minute and second hands 11 are arranged is larger in the glass 4 direction than a thickness of a dial peripheral edge 5a on which the dial trim ring 2 is mounted. Further, an inclined surface portion 5d which is configured so that the thickness of the dial is reduced toward the peripheral edge side 5a from the inner side 5b is formed at a position filling a difference between the dial peripheral edge 5a and the dial inner side 5b.

This difference and the inclined surface 5d form a light leading portion 2a for a light, thereby assuring a fixed width of an inlet of a light with respect to the dial trim ring 2. As a result, a necessary power generation quantity can be assured and, at the same time, a gap between the glass 4 and the dial 5 can realize a depth comparable to that of a conventional electronic watch having a primary battery by increasing the dial thickness of the dial inner side 5b.

Furthermore, a part of the photovoltaic area 1a (a hatched part of the solar cell 1 in FIG. 1) of the solar cell 1 and a part 2b of the dial trim ring 2 which covers the photovoltaic area 1a of the solar cell 1 are arranged below a position of a dial upper surface 5c. By doing so, a gap from the glass 4 to an upper surface of the dial peripheral edge 5a on which the dial trim ring 2 is arranged can be narrowed. Moreover, a light transmitted through the dial trim ring 2 which is a light leading member is emitted from the part 2b of the dial trim ring 2, and a power can be likewise generated in the part of the solar cell 1 arranged below the position of the dial upper surface 5c.

Additionally, an air layer 9 exists between the dial trim ring 2 and the solar cell 1, and a part of the light transmitted through the dial trim ring 2 is reflected and scattered on an interface, thereby making it hard to see the dark brown color of the solar cell 1 from the outside.

Further, the electrode portions 1b and 1c of the solar cell 1 protrude to a case back 10 side via a hole portion 6a of the watch movement 6. Two connection springs 8 are arranged on the case back 10 side. This connection spring 8 is fixed to a non-illustrated circuit board through a plate holding an insulating sheet. An end portion 8a of this connection spring 8 is brought into contact with the positive and negative electrodes 1b and 1c of the solar cell so that the generated power from the solar cell 1 is led to the circuit board.

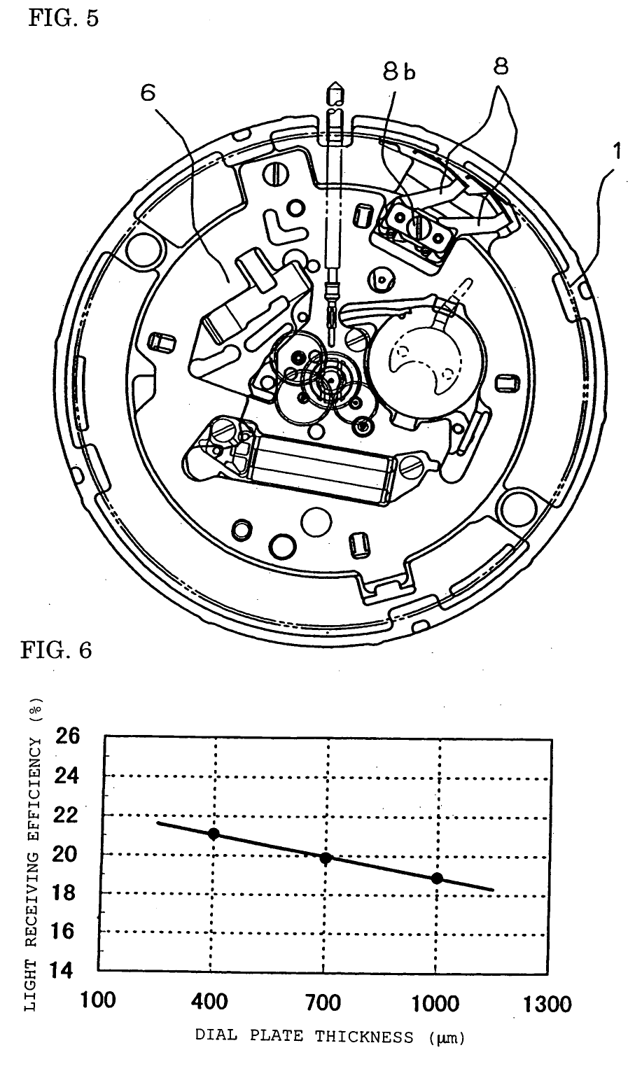

FIG. 5 is a plan view showing the watch movement 6 depicted in FIG. 1 from the case back side, and shows an arrangement relationship of the two connection springs 8, the solar cell 1 and others in plan. The connection spring 8 is held and fixed by a screw 8b or the like in order to achieve electrical connection between the solar cell 1 and the circuit board.

### Embodiment 1

A description will now be given as to a difference in power generation performance between an electronic watch with a solar cell using the dial 5 having a large thickness on the inner side 5b and an electronic watch with a solar cell using a flat dial with reference to Table 1, FIG. 1 and FIG. 6.

In case of a general flat dial, a thickness A is approximately 400 μm. On the contrary, as to the dial shown in FIG. 1, the power generation performance was measured when a dimension D of the peripheral edge 5a on which the dial trim ring 2 is mounted is determined as 300 μm and a thickness B of the inner side 5b which is increased by providing the inclined surface at an angle of 45 degrees from the inner periphery is changed to 700 μm and 1000 μm, and Table 1 shows a result of this measurement. It is to be noted that a lower end of the photovoltaic area 1a of the solar cell at this moment is placed at a position reaching the same height as the lower surface 5e of the dial 5.

TABLE 1

| | Power | Light | |
|---|---|---|---|
| Dial | generation | receiving | Gap dimension |
| thickness (B) | current lop | efficiency | from glass to |
| (μm) | (μA) | (%) *1 | dial (C) (μm) |
| 400 (=A) | 12.7 | 21.1 | 2150 |
| 700 | 11.9 | 19.9 | 1850 |
| 1000 | 11.3 | 18.9 | 1550 |

A state when assembled in a finished watch
The Illuminance = 500 lux; an operating voltage = 0.45 V
A color of the dial = black
n = an average value of 5
*1 a percentage of an acquired current with respect to a power generation current 60 μA of a horizontally set solar cell.

Table 1 shows measured values of the power generation current and the light receiving efficiency in a finished watch when the dial thickness B is changed and the gap dimension C from the glass to the dial under the condition that the illuminance is 500 lux, a solar cell operating voltage is 0.45 V and a color of the dial is black.

It is to be noted that the light receiving efficiency is a percentage of a power generation current when a light having the same illuminance as that of the single solar cell unit is applied from a direction orthogonal to the dial (a direction parallel to the solar cell) in the finished watch in which the solar cell is assembled with respect to a power generation current value when a light is applied from a direction vertical to the photovoltaic area in a state where the single solar cell unit is horizontally placed, and a measured value indicates an average value of n=5. Moreover, the dial trim ring used in the measurement is formed of transparent and colorless polycarbonate resin which has the light permeability by injection molding, and a surface of the dial trim ring is a glossy surface.

As shown in Table 1, the light receiving efficiency is 21.1% in the dial with an even thickness whose dial thickness is 400 μm, whereas the light receiving efficiencies are 19.9% and 18.9% in the dial whose dial thickness is set to 700 μm and 1000 μm by increasing the thickness of the dial inner side.

FIG. 6 shows the data of Table 1 in the form of a graph of the light receiving efficiency with respect to the dial thickness, and there is indicated a tendency that the light receiving efficiency is lowered as the dial thickness is increased as shown in FIG. 6. This result implies that the light leading portion 2a for a light is narrowed as the thickness (B) of the dial 5 depicted in FIG. 1 is increased and a light is hence hard to enter, and this is a natural consequence.

A relationship between a watch power consumption and a power generation quantity by the solar cell will now be described.

[About Watch Power Consumption]

A specification of an electronic watch with a solar cell used in the description of this embodiment is an analog watch with three hands and a date, and it is determined that a watch power consumption=0.53 μA. Therefore, there is obtained a power consumption required for driving the hands for
a day=a watch power consumption×24 hr=12.7 μA·Hr (1)
[About Power Generation Quantity]

A specification of the solar cell utilized by the watch used in this embodiment is as follows:
Solar cell outside size=a length 92.1 mm, a width 2.4 mm Solar cell light receiving portion effective size=a length 91.3 mm, a width 1.6 mm

$$A power generation effective superficial content = 146 {mm}^{2} ( a peripheral edge width = approximately 0.4 mm )$$

The number of solar stages=one

In regard to the power generation performance of the solar cell, the illuminance is 500 lux, an operation voltage is 0.45 V, and a power generation current when the solar cell is horizontally set=60 μA.

In regard to the electronic watch with the solar cell according to this embodiment, an open circuit voltage Voc of the solar cell in the electronic watch using one stage of the solar cell is 0.6 V, and the power generation voltage must be boosted in order to charge an Li secondary battery with a rated voltage of 1.35 V. As to a specification of a booster system, assuming that a boosting ratio is threefold and a boosting efficiency is 90%, a power generation quantity in the finished watch under the average light irradiation condition per day can be calculated based on the following expression:
=an irradiation time×a power generation current×a light receiving efficiency+a boosting ratio×a boosting efficiency (2)

Incidentally, it is assumed that the average light illuminance per day is 500 lux and the average irradiation time is 4 hr.

If the power generation quantity in the finished watch under the average irradiation condition per day in (2) is larger than the power consumption required for driving hands for a day in (1), the finished watch can be realized as a watch, and the minimum light receiving efficiency for this realization can be calculated based on the following expression. That is,
A watch power consumption×24 hr≦an irradiation time×a power generation current×a light receiving efficiency+a boosting ratio×a boosting efficiency.

Therefore,

$$the minimum light receiving efficiency = a watch power consumption \times 24 hr \div an irradiation time \div a power generation current \times a boosting ratio \div a boosting efficiency = 0.53 μ A \times 24 hr \div 4 hr \div 60 μ A \times 3 \div 90 \% = 17.7 \%$$

Accordingly, if the light receiving efficiency is not less than 17.7%, the finished watch can be realized as a watch.

The gap dimension C between the glass and the dial of the conventional electronic watch with three hands having a primary battery is approximately 1500 to 1600 μm, whereas, when the dial thickness B is 1000 μm as shown in Table 1, the gap dimension C is 1550 μm which is equivalent to that of the conventional electronic watch with three hands having the primary battery, and the light receiving efficiency at this time is 18.9%. Therefore, a value larger than the calculated value 17.7% of the minimum light receiving efficiency can be obtained, the power generation quantity with which the watch can function can be obtained, and the gap dimension between the glass and the dial can be set equivalent to that of the conventional watch with three hands having the primary battery.

### Embodiment 2

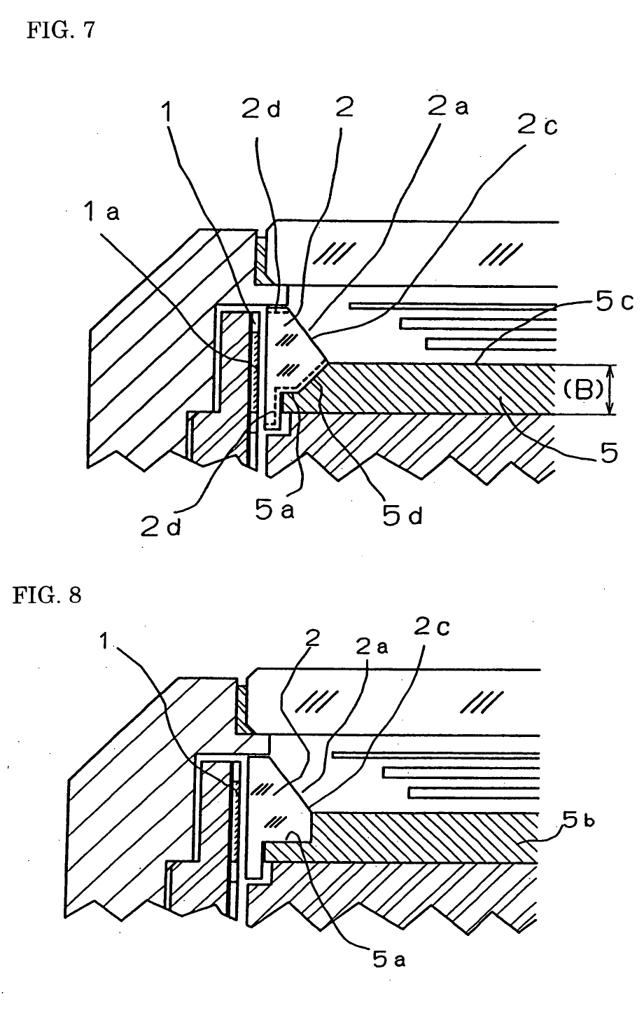

FIG. 7 is a cross-sectional view of a primary part of an electronic watch with a solar cell according to the present invention, showing Embodiment 2. In Embodiment 2, as compared with FIG. 1, the inclined surface portion 2c in the light leading portion 2a of the dial trim ring 2 is caused to project toward the central side of the watch, an extension line of the inclined surface of the inclined surface portion 2c is set to cross an extension line of the wall thickness upper surface 5c of a wall thickness portion (B) of the dial 5, and 5d as the inclined surface of the light leading portion of the dial 5 is covered with the inclined surface 2c. When the dial trim ring 2 is formed into a shape with which the dial inclined surface 5d is covered as shown in FIG. 7, the step between the dial trim ring 2 and the dial inclined surface portion 5d shown in FIG. 1 can be eliminated, and a superficial content of the light leading portion 2a for a light with respect to the solar cell 1 can be assured.

### Embodiment 3

FIG. 8 is a cross-sectional view of a primary part of an electronic watch with a solar cell according to the present invention, showing Embodiment 3. In Embodiment 3, as compared with FIG. 1, the inclined surface portion 2c in the light leading portion 2a of the dial trim ring 2 is caused to project toward the central side of the watch, an extension line of the inclined surface of the inclined surface portion 2c is set to cross an extension line of the wall thickness upper surface 5c of the wall thickness portion (B) of the dial 5, and 5d as the inclined surface of the light leading portion of the dial 5 is covered with the inclined surface portion 2c. When a superficial content of the light leading portion 2a for a light with respect to the solar cell 1 is assured as shown in FIG. 8, it is possible to adopt a structure in which the dial peripheral edge 5a and the dial inner side 5b of the dial 5 are connected with each other through the step. Although formation of the step at the dial outer peripheral portion can be readily performed by press working, milling or the like, this formation can be likewise realized by attaching two circular plates having different outside diameters to each other, and there is a merit that processing is facilitated as compared with the structure in which an inclined surface is formed.

### Embodiment 4

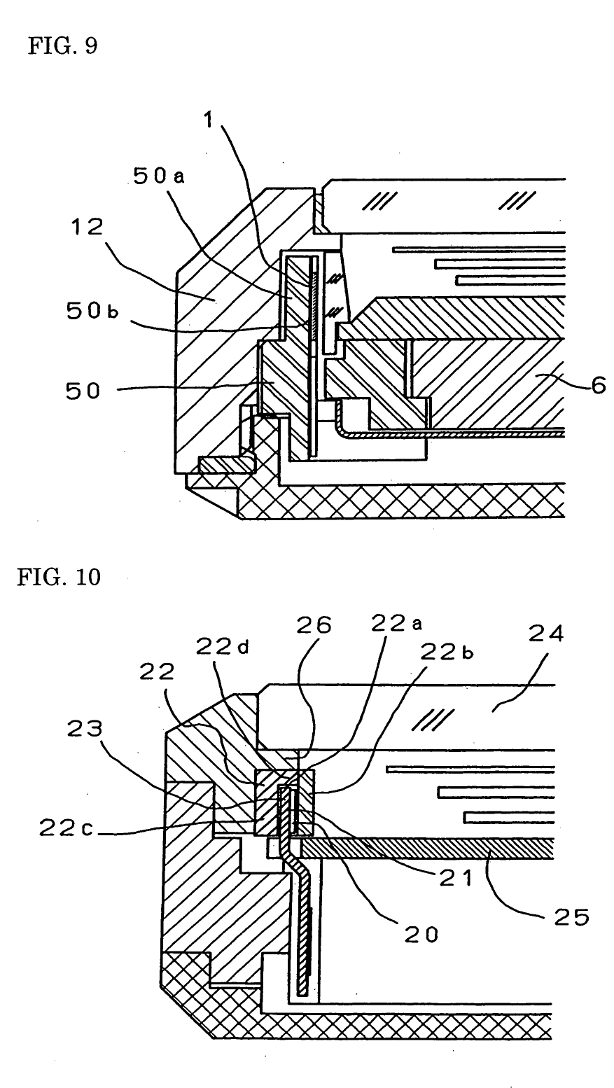

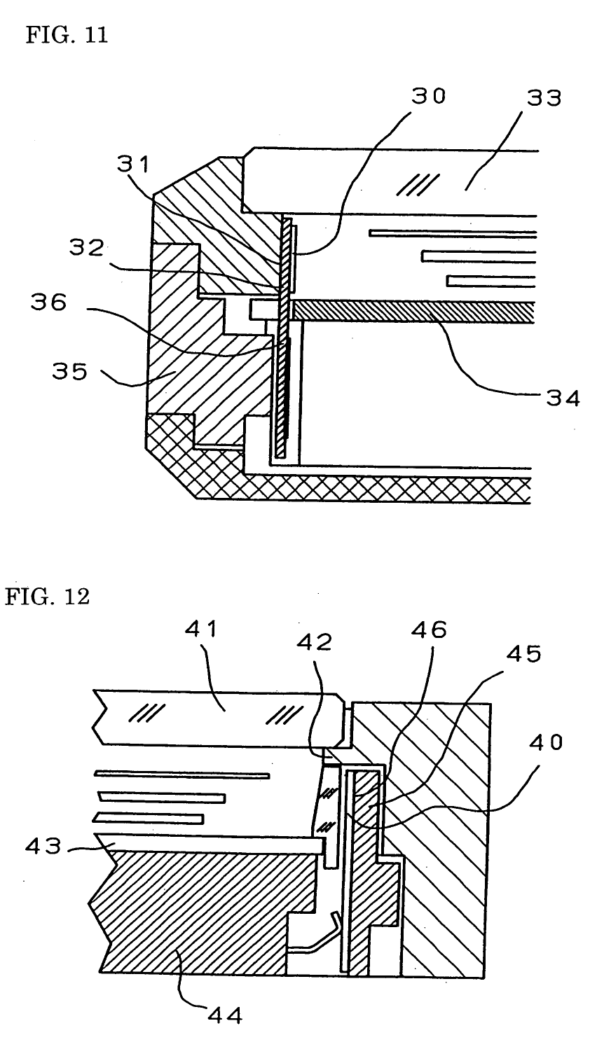

FIG. 9 is a cross-sectional view of a primary part of an electronic watch with a solar cell according to the present invention, showing Embodiment 4 of the present invention. In Embodiment 1 to Embodiment 3, the description has been given on the structure in which the solar cell 1 is arranged at the annular convex portion 3a which is provided to the circuit support 3 as a component of the watch movement 6 and used for positioning the solar cell 1. FIG. 9 shows a structure in which an annular convex portion 50a which is used for positioning of the solar cell is provided in a casing frame 50 as an exterior component which is used when accommodating the watch movement 6 in the watch case 12 and the solar cell 1 is arranged on an inner wall surface 50b of this convex portion 50a. Embodiment 4 can be carried out in the watch structure in Embodiment 2.

It is to be noted that the casing frame is an exterior component which accommodates and holds the watch movement in the watch case when assembling the watch movement in the watch case, and also absorbs impact shocks from the outside of the watch.

### Embodiment 5

In FIG. 7, a reflection film comprising a thin film of, e.g., aluminum is attached on a surface 2d (a surface indicated by a broken line) which is not a surface which emits a light toward the solar cell by vapor deposition or the like on a light incidence surface of the dial trim ring 2 which takes in an external light. The reflection film can prevent a light from leaking toward the outside of the dial trim ring 2 from the surface 2d, and a quantity of the light which enters the solar cell 1 can be thereby increased, thus increasing a power generation quantity.

Moreover, in FIGS. 1, 2, 8 and 9, a power generation quantity can be likewise increased by providing the reflection film to the dial trim ring.

It is to be noted that the light receiving efficiency also varies depending on a color of the dial, and the light receiving efficiency is increased when the dial having a white color or a bright color which readily causes reflection of a light on the dial is used, whilst the light receiving efficiency is reduced when a color of the dial is black. In regard to the black color and the white color as the dial color, the light receiving efficiency is doubled or more when the white color is used.

As described above, according to the first embodiment, in the electronic watch with the solar cell which is arranged substantially vertically with respect to the dial, the gap between the glass lower surface and the dial upper surface can be reduced by arranging the light permeable dial trim ring on the inner side of the solar cell and also arranging a part of the solar cell photovoltaic area and a part of the dial trim ring which covers the solar cell photovoltaic area to be lower than the dial upper surface height, and by increasing the dial thickness of the dial inner side to be larger than the thickness of the dial peripheral edge on which the dial trim ring is mounted while assuring a quantity of a light which enters the solar cell which is used to obtain a power required for driving the watch, and this gap is set equivalent to that of the conventional electronic watch having a primary battery, thereby eliminating the hollow-eyed appearance.

### Second Embodiment

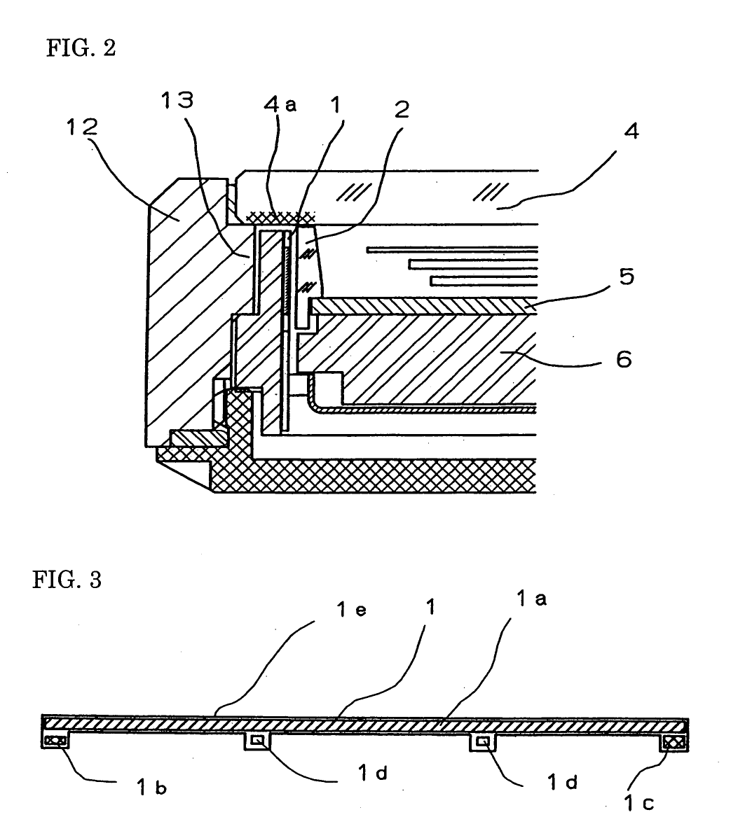

FIG. 2 is a cross-sectional view of a primary part showing a second embodiment of the present invention. In this embodiment, the watch movement 6 described in the first embodiment in which the light permeable dial trim ring 2 is attached on the outer periphery of the dial 5 is used, but a general flat dial 5 having a thickness of 400 μm is used as the dial 5. Additionally, the flange portion 13 which holds and fixes the glass 4 is incorporated in the watch case 12 which is positioned on the outer side and the upper surface side of the solar cell 1 and the dial trim ring 2. The solar cell 1 and the dial trim ring 2 are arranged directly below the glass 4 in close proximity, and an annular print 4a or the like is provided on the lower surface of the glass 4 at a position where the solar cell 1 and the dial trim ring 2 are arranged.

A thickness of the flange portion 26 in the prior art shown in FIG. 10 can be eliminated by placing the flange portion 13 which accepts and fixes the glass 4 in the watch structure shown in FIG. 2 on the outer side of the solar cell 1 and the dial trim ring 2. As a result, the gap between the glass 4 and the dial 5 is 2150 μm when the dial 5 having a thickness of 400 μm is used as described in connection with Embodiment 1, whereas this gap can be reduced to 1700 μm. This gap becomes substantially equivalent to that of the conventional electronic watch with three hands having a primary battery, and the “hollow-eyed” design can be eliminated.

Further, the solar cell 1, the dial trim ring 2 and others can be covered so that they are invisible from the outside of the watch case 12 by providing the annular print or a metallic film 4a to the glass lower surface directly above the dial trim ring 2 and the solar cell 1, thereby improving the external appearance quality.

In regard to a power generation quantity of the watch described in the second embodiment, the light receiving efficiency is approximately 21.1% which is equivalent to that obtained when a flat dial having a dial thickness of 400 μm is used in the first embodiment, and the sufficient power generation quantity is obtained as compared with the watch having the specification described in Embodiment 1 of the first embodiment.

It is to be noted that the description has been given by using the solar cell which is a strip-like electronic cell in this embodiment, it is possible to use a solar cell such as a two-stage cell in which right and left solar cells having the same size are provided.

As described above, according to the second embodiment, in the electronic watch with the solar cell which is arranged substantially vertical with respect to the dial, the gap between the glass lower surface and the dial upper surface can be narrowed by arranging the light permeable dial trim ring on the inner side of the solar cell and placing a part of the solar cell photovoltaic area and a part of the dial trim ring which covers the solar cell photovoltaic area to be lower than the dial upper surface height, and the “hollow-eyed” design can be eliminated by setting this gap to be equivalent to that of the conventional electronic watch having a primary battery.

### INDUSTRIAL APPLICABILITY

According to the present invention, the gap between the glass lower surface and the dial upper surface can be narrowed by increasing the thickness of the dial inner side to be larger than the thickness of the dial peripheral edge while assuring the light leading portion for a light which enters the dial trim ring, thereby providing the electronic watch with the solar cell in which the “hollow-eyed” design is eliminated.

1. An electronic watch with a solar cell which is arranged substantially vertically with respect to a dial,
wherein a light leading portion is provided at a peripheral edge of the dial, a light permeable dial trim ring is arranged at the peripheral edge of the dial, and a part of a photovoltaic area of the solar cell and a part of the dial trim ring which covers the photovoltaic area of the solar cell are arranged to be lower than a dial upper surface height.

2. The electronic watch with a solar cell according to claim 1, wherein a thickness of the inner side of the dial is set larger than that of the peripheral edge.

3. The electronic watch with a solar cell according to claim 1, wherein the light leading portion has an inclined surface portion which is configured in such a manner that a thickness of the dial is reduced from the inner side toward the peripheral edge side.

4. The electronic watch with a solar cell according to claim 1, wherein the light leading portion has a step portion configured in such a manner that a thickness of the dial is reduced at the peripheral edge.

5. The electronic watch with a solar cell according to claim 3, wherein an inclined surface portion is provided to the dial trim ring, and an inclined surface or a step portion of the light leading portion of the dial is covered with the inclined surface portion.

6. The electronic watch with a solar cell according to claim 1, wherein a flange portion which fixes a glass to a watch case of the electronic watch with the solar cell is provided outside the dial trim ring, the solar cell and a watch movement or an annular convex portion of a casing frame which holds the solar cell; the dial trim ring is arranged directly below the glass; and a blind portion is provided above the dial trim ring of the glass and/or the solar cell.
